(19) United States
(12) Patent Application Publication
(10) Pub. No.: US 2005/0074268 A1
(43) Pub. Date: Apr. 7, 2005

(54) Drawing or writing utensil and casing or protective sleeve

(76) Inventor: Johann Beil, Lam (DE)

Correspondence Address: HOFFMAN, WASSON & GITLER, P.C.;CRYSTAL CENTER 2, SUITE 522, 2461 SOUTH CLARK STREET, ARLINGTON, VA, 22202, US

(21) Appl. No.: 10/868,354

(22) Filed: Jun. 16, 2004

(30) Foreign Application Priority Data
Jun. 18, 2003 (DE) 103 27 384.0
Oct. 23, 2003 (DE) 103 49 733.1

(51) Int. Cl. B43K 5/16

(52) U.S. Cl. 401/107

(57) ABSTRACT

In a writing and/or drawing utensil, an inner writing and/or drawing element or an inner pen with a writing or drawing tip is accommodated in an external casing and can move axially so that the writing and or drawing tip is movable from a retracted non-use position into a use position. By means of a closure the writing and/or drawing tip is closed in non-use position.

### BACKGROUND OF THE INVENTION

The invention relates to a writing and/or drawing utensil and to a casing or a protective sleeve.

Writing and drawing pens are known in the art that are commonly referred to as “felt tip pens” in the broadest sense and that consist essentially of an elongated, sleeve-like pen body, a writing and drawing tip located at one end of the pen body and a reservoir in the interior of the pen body that provides or feeds the writing or drawing tip with a writing or drawing fluid, for example ink. The drawing or writing tip is manufactured from a porous, but sufficiently hard material, for example from a porous plastic or composite material. A pen of this type with the brand name “edding”, for example, is available on the market.

One of the disadvantages of such writing and drawing utensils is, for example, that they dry out easily, namely when the end of the pen containing the writing and drawing tip is not closed properly by putting on a closing cap when not in use, which however is neglected in many cases either out of laziness or because the cap has been lost.

An object of the invention is to eliminate this disadvantage.

### SUMMARY OF THE INVENTION

The writing or drawing utensil according to the invention is made up of the writing or drawing pen, of the conventional types and of a protective sleeve at least partially accommodating this pen, i.e. in the proximity of its writing and drawing tip, which (protective sleeve) has a closure with a closure aperture on the end adjacent to the writing and drawing tip. When not in uses the writing and drawing tip is located within the protective sleeve, namely with the closure aperture closed, and is therefore protected from drying out. From the non-use position, the pen can be moved within the protective sleeve and axially relative to the latter into the use position. This causes the pen to open the closure aperture of the protective sleeve, so that in the use position the writing and drawing tip of the pen protrudes from the protective sleeve through the open closure aperture. Upon moving the pen 2 back into the non-use position the writing or drawing tip is likewise moved backed into the protective sleeve, whereby the closure aperture automatically closes, so that the pen is again protected in the protective sleeve.

“Non-use position”, according to the invention means the position in which the pen (felt tip pen) is moved back or withdrawn in the outer casing or in the protective sleeve such that the writing and/or drawing tip of the pen is accommodated in the protective room or space that is outwardly closed by the closed closure and therefore the pen, and its writing and/or drawing tip, is protected from drying out.

“Use position”, according to the invention, accordingly means the position of the pen within the outer casing, in which the writing and/or drawing tip protrudes outward through the open closure or through the closure aperture formed by the open closure.

In the invention, the closed closure or its closure element forms a cap-shaped, for example cone-shaped or tapered casing end, in which also the protective space is formed.

### BRIEF DESCRIPTION OF THE DRAWINGS

Exemplary embodiments of the invention are described below with reference to the drawings, in which:

FIG. 1 shows a writing or drawing utensil in side view and in partial cross section, with the writing or drawing tip retracted;

FIG. 2 shows a similar representation as FIG. 1, however with the writing or drawing tip extended;

FIGS. 3, 4 each shows an enlarged, detailed partial view of FIGS. 1 and 2;

FIG. 5 shows a section corresponding to the line I-I of FIG. 3;

FIGS. 6, 7 each shows in sections similar to FIG. 1 a further possible embodiment of the invention, with the writing and/or drawing tip retracted and with the writing and/or drawing tip extended;

FIG. 8 shows an enlarged partial view of two closure elements; and

FIG. 9 shows a section corresponding to the line I-I of FIG. 8.

### BRIEF DESCRIPTION OF THE INVENTION

The writing or drawing utensil generally designated 1 in the drawings is made up of an inner pen 2 of conventional design and an outer sleeve-like casing or sleeve 3 enclosing the pen 2.

The pen 2 is designed as a fiber or felt tip pen in the broadest sense and is made up of a cylindrical or sleeve-shaped pen body 4, which is closed at both ends, namely on the upper end in the drawings by a closure element 5 and on its lower end in the drawings by a closure cap 6 that is screwed onto the pen body with a section 6.1 and tapers toward its free end. In this closure cap, a writing or drawing tip 7 is held that extends into the interior of the pen body 4 with one end and protrudes beyond the free end of the closure cap with its other end and is manufactured as a porous body from a sufficiently hard composite material. The closure cap 6 is formed so that it has a conically tapered section 6.2 connecting to the essentially cylindrical section 6.1 that can be screwed onto the pen body 5 and connecting to the section 6.2 a section 6.3 that forms the free end of the closure cap 6 and is designed to be essentially cylindrical at least on its outer surface.

The pen body 4 serves to hold a supply of writing or drawing fluid (ink), which is continuously provided to the writing tip 7 during writing or drawing.

The sleeve 2 serves, for example, to protect this pen and its writing or drawing tip 7 from drying out in the non-use position.

The sleeve 3 is made up of a cylindrical or hollow cylindrical sleeve body 8, in which the pen 2 is axially movable. At its upper end the sleeve body 8 is open, namely such that with the pen 2 inserted into the sleeve 3, the pen protrudes with its end formed by the closure element 5 from the protective sleeve 3 and the pen 2 is situated with its longitudinal axis on the same axis as the longitudinal axis L of the protective sleeve 3.

At the lower end, the sleeve body 8 of the protective sleeve 3 is closed, namely by the fact that the sleeve body 8 forms a truncated cone-shaped section 8.1 there, which ends at one aperture 9 that is situated on the same axis as the longitudinal axis L and the diameter of which is somewhat greater than the outer diameter of the essentially cylindrical section 6.3 of the closure cap 6.

At the edge of the aperture 9, a plurality of fingers or fins 8.2 are molded on at regular angle intervals on the longitudinal axis L and located on an imaginary common cone surface that is on the same axis as the longitudinal axis L, namely such that the radial distance of each fin 8.2 from the longitudinal axis L reduces as the distance from the section 8.1 increases. The fins 8.2 each form an angle with the longitudinal axis L that is considerably smaller than half the cone angle of the section 8.1.

Furthermore, the free ends of the fins 8.2 are located on an imaginary circular line around the longitudinal axis L and have a diameter that is approximately equal to the maximum diameter of the part of the writing or drawing tip 7 that protrudes from the closure cap 6.

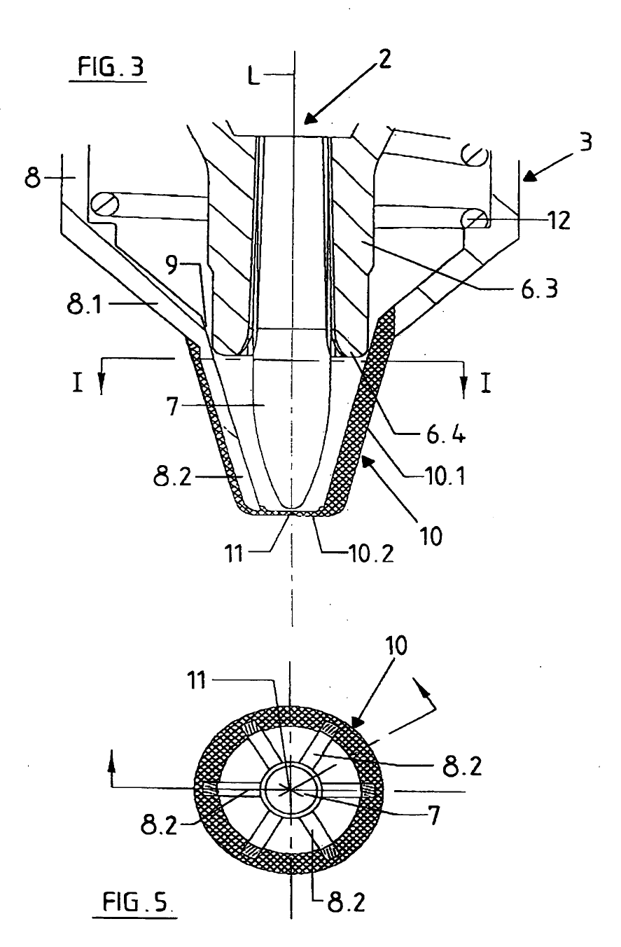

On the element (spreading element) of the sleeve body 8 formed by the fins 8.2 a cap 10 made of a rubber-elastic material is attached, namely such that this cap 10 tightly closes the sleeve body 8 at the section 8.1 and in the area of the fins 8.2, while the fins 8.2 lie freely within the cap 10. The cap 10 thus has a truncated cone-shaped tapered wall section 10.1 corresponding to the gradient of the fins 8.2 and a bottom 10.2 that is situated in a plane perpendicular to the longitudinal axis L. On this bottom 10.2 the cap 10 forms an aperture 11 which however in the state depicted in FIGS. 1 and 3 is closed by the bottom 10.2 or by lip-shaped sections formed by the bottom 10.2 contiguous to the aperture 11. The fins 8.2 are spring-mounted.

In the protective sleeve 3, there is furthermore a compression spring 12 that encloses the closure cap 6 or its section 6.2 and 6.3 at least partially and with its upper end in the drawings supports a collar that is formed on the closure cap 6 at the transition between the sections 6.1 and 6.2 and with its lower end supports a collar that is formed on the inside of the protective cap 3 at the transition between the sleeve body 8 and the section 8.1. By means of the spring 12 the pen 2 is held in its non-use position depicted in FIGS. 1 and 3, in which position the writing or drawing tip 7 is protected within the protective space closed by the cap 10.

When the pen 2 is now moved axially against the action or force of the spring 12 within the protective sleeve 3, first the free edge 6.4 of the section 6.3 of the closure cap 6 comes to bear against the surfaces of the fins 8.2 facing the longitudinal axis L, so that with the increasing continued movement of the pen 2 from the non-use position into the use position the spring-mounted fins 8.2 are increasingly moved or spread apart radially, therefore stretching the cap 10 made of the rubber-elastic material so that the aperture 11 for the writing tip 7 is opened, namely without the writing tip 7 itself having to act upon the cap 10 or its bottom 10.2.

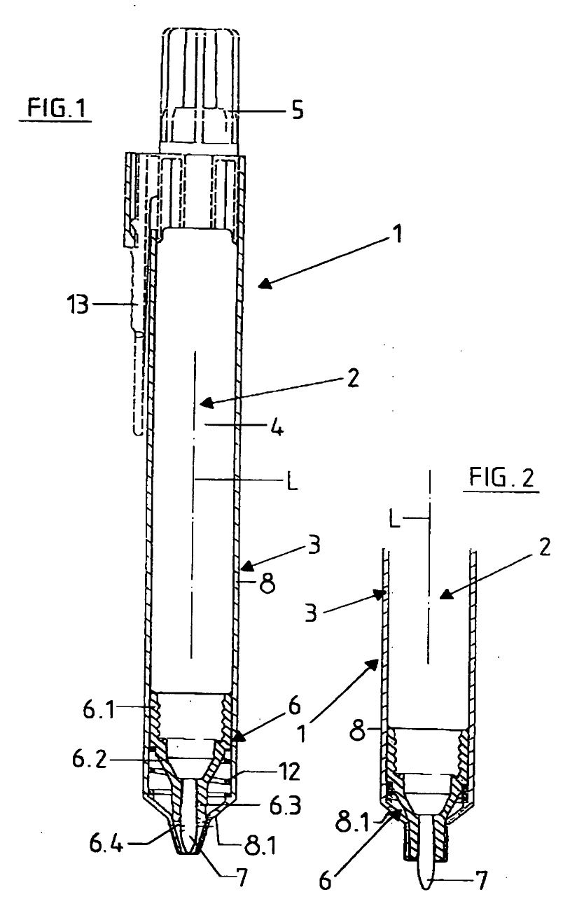

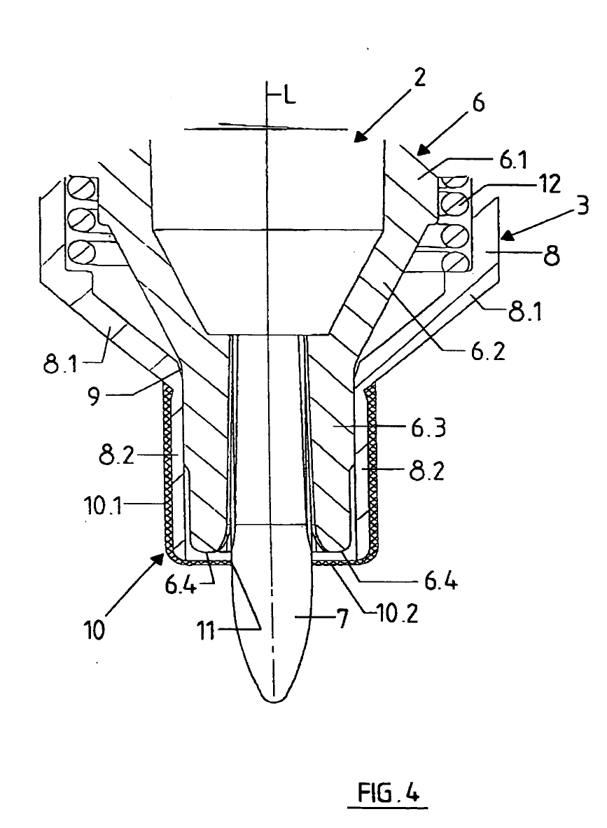

By means of a suitable locking mechanism, which is generally designated 13 in FIG. 1, the pen 2 can be locked in its writing and drawing position depicted in FIGS. 2 and 4, in which position the writing and drawing tip 7 protrudes through the aperture 11 from the protective sleeve 3 and its cap 10. After releasing the locking mechanism 13 the pen 2 is again moved by the spring 12 back into its non-use position. Hereby the fins 8.2 return to their original position, therefore enabling the aperture 11 to close again.

The sleeve body 8 is manufactured as one piece with its sections from a suitable, resilient material, for example from a suitable plastic. The cap 10 is made, as described, of a softer rubber-elastic material, for example of an elastomer plastic and is preferably molded onto the section 8.1 and the fins 8.2.

The aperture 11, which in the depicted embodiment is cross-shaped, but can also have another suitable shape, is manufactured by stamping, for example. Generally it is also possible to produce this aperture 11 by means of a tool as a slit-shaped aperture, for example, during manufacture of the cap 10, whereby in this case during molding of the cap 10 the fins 8.2 are spread apart somewhat in order to ensure that after forming of the cap 10, the aperture 11 manufactured in the molding die closes by the spring-mounted fins 8.2 returning to their original position or is closed by lip-shaped areas of the bottom 10.2 contiguous to the aperture 11.

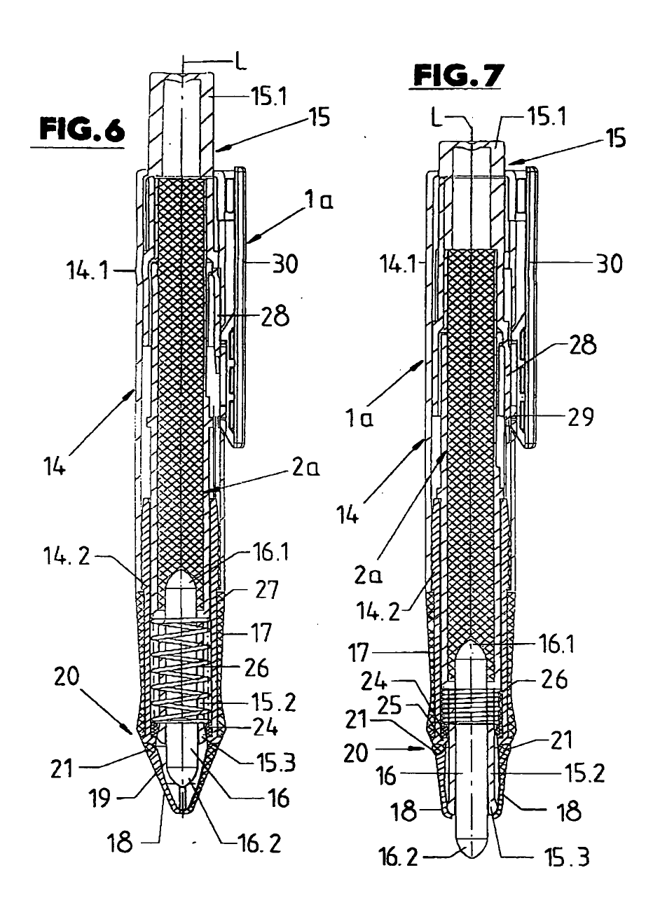

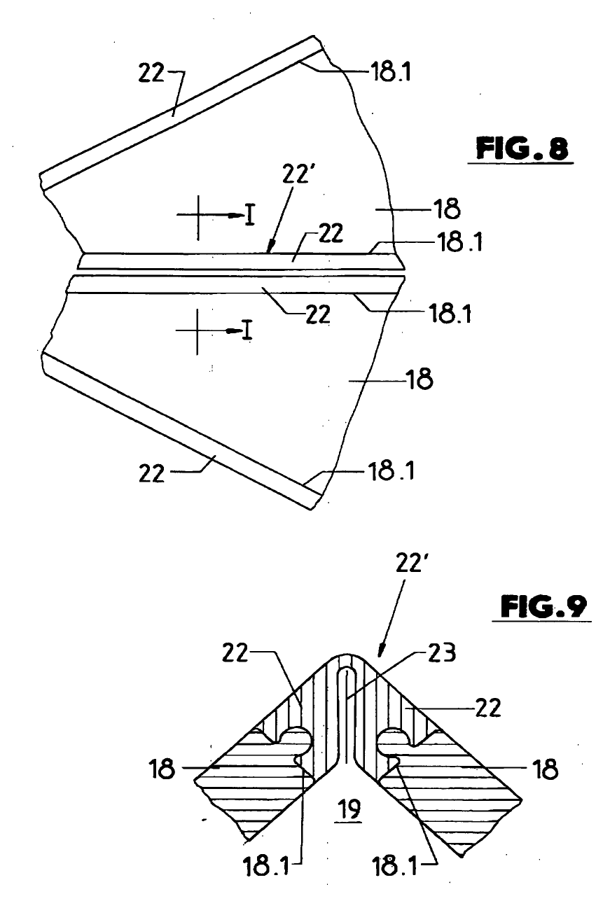

FIGS. 6-9 show a writing and/or drawing utensil la, which like the writing and/or drawing utensil 1 consists of an inner pen 2a and an outer sleeve or hollow body 3a enclosing the pen 2a. The pen 2a is likewise designed as a fiber or felt tip pin in the broadest sense and consists essentially of a cylindrical or sleeve-shaped pen body 15, which is closed on its upper end 15.1 in FIGS. 6 and 7 and forms a button that protrudes from the upper end of the outer sleeve 14. The pen body 15 contains a fiber rod or porous rod saturated with ink to which one end 16.1 of a writing tip 16 is connected that is situated in the area of the lower end of the pen 2a on the same axis as the pen body 15, the writing tip protruding with its other end 16.2 from the lower end of the pen body 15 and forming the actual writing and/or drawing tip with this end 16.2. In the area 15.2 that encloses the writing tip 16 the pen body 15 has a somewhat reduced outer diameter. Furthermore, the pen body 15, at its lower end, i.e. where the writing and/or drawing tip 16 leads up from the pen body 15, has a ring-shaped bead extending slightly over the remaining peripheral side and concentrically enclosing the axis of the pen body.

In the depicted embodiment, the outer casing or the outer sleeve 14 is designed as two parts, i.e. it consists of an upper sleeve section 14.1 in FIGS. 6 and 7 that has on its end also the aperture for the end 15.1 of the pen body, and of a lower sleeve section 14.2 in the drawings that is connected with and overlaps the sleeve section 14.1 and that is provided on its outer surface in the area of the lower end of the writing utensil with an outer layer 17 that concentrically encloses the axis of the writing utensil 1a and is made of a soft, elastomer material, which provides for a better grip on the writing and/or drawing utensil in this grip area, where the writing and drawing utensil is normally held during normal use. For better handling, the writing and/or drawing utensil la is slightly reduced on the outer surface of the layer 17.

The section 14.2 forms on the lower end of the writing utensil a plurality of flap-like closure elements 18 located on the axis L of this writing utensil which (closure elements), when the writing tip 16 is retracted or moved back into the outer sleeve 14, forms a protective space 19 that is closed toward the outside and in which the part of the writing and/or drawing tip 16 protruding from the lower end of the pen body 15 is fully accommodated and into which also the lower end of the pen body or of the section 15.2 of this pen body extends. The flap-shaped closure elements 18 complement one another in this retracted state of the pen 2a to form a cone-shaped wall or cap that closes the protective space 19 toward the outside, as depicted in FIG. 6.

Upon forward movement of the pen 2a, or upon outward movement of the writing and drawing tip 16 from the lower end of the outer sleeve 14, the ring-shaped bead 15a first comes to bear against the inner surface of the closure elements 18, so that the latter are pivoted outward on axes tangential to the axis of the writing and/or drawing utensil 1d (without coming into contact with the writing and/or drawing tip) and therefore the writing and/or drawing tip protrudes outward from the aperture now released by the closure elements. This use position is depicted in FIG. 7.

The closure elements 18, which are manufactured from plastic as one piece with the sleeve section 14.2, thereby pivot in an area designated 20 in the drawings, on which, with the protective space 19 closed or in non-use position, the closure elements which are then oriented diagonally to the longitudinal axis of the writing and/or drawing utensil pass over into the essentially cylindrical part of the sleeve section 14.2 that concentrically encloses the longitudinal axis L. The hinge areas 20 are formed by sections on which the wall thickness of the sleeve section 14.2 is reduced on the outside. In the thereby formed grooves or recesses, an elastomer material that is softer than the material of the sleeve section 14.2 is inserted in order to increase the pull-back or closing force of the closure elements 18, as designated by 21.

The edge areas 18.1 of the closure elements 18 on which the latter are closely connected to each other in the state in which they close the protective space 19 and which have a gradient corresponding to a lateral surface of a cone, are each provided in the depicted embodiment with an edge layer or seal 22 made of an elastomer plastic, so as to enable an effectively tight seal of the protective space 19 by the closure elements 18.

As indicated in FIG. 9, the edge layers 22 are manufactured by molding a material section or strip 22′ from the elastomer plastic between each of the edges of the closure elements 18, this strip 22′ having a thin section with a reduced wall thickness or a break-off line 23 in the middle and parallel to the contiguous edges of the adjacent closure elements 18, on which (break-off line) the material strip 22′ upon opening of the protective space 19 for the first time, i.e. upon the first spreading of the closure elements 18, breaks apart so that this also provides an original seal and in particular also so that the pen 2a is protected from drying out before the first use by hermetically sealing the protective space 19 in the area of the closure elements 18.

In the protective space 19, there is a ring seal 24 enclosing the section 15.2 that with one side, i.e. with the side facing the closure element 18, supports a collar 25 formed on the inside of the sleeve section 14.2. On the other side of the seal 14 a compression spring 26 is supported with one end and encloses the section 15.2 with the reduced outer diameter and is supported on a transition between the section 15.2 and the remaining pen body 15 on this collar 27. By means of the compression spring 26 therefore the felt tip pen 2a is pre-tensioned in a retracted position, i.e. the non-use position, in which the ring-shaped bead 15.3 bears against the sealing ring 24, which at the same time is also supported by the compression spring 26, so that the protective space 19 is also tightly closed toward the interior of the sleeve 14.

In particular the layer 17, the elastic material inserts 21 and the sealing strips or edge seals 22 or the material strips 22′ forming these edge seals located on the edges of the closure elements 18, and also the ring seal 24 are preferably manufactured together with the sleeve sections 14.2 using a multi-injection molding process.

From the non-use position (FIG. 6), the felt tip pen 2a is moved into the use position (FIG. 7) by pressing on the end 15.1 against the action of the compression spring 26. In order to maintain the use position against the action of the compression spring 26, a locking pin 29 is molded onto a spring-mounted section 28 connected with this pen body which (locking pin) extends radially over the outside of the section 28 and acts together with a control surface located on a holding clip 30 so that the pin 29, upon pushing the felt tip pen 2a forward on a catch of the locking and control curve, locks into place and this locked state can then be released by lifting the holding clip 30. The locking and control curve acting together with the pin 29 and located on the side facing the sleeve 14 can also be designed so that the pin 29, upon moving the felt tip pen 2a forward, first locks into place in order to hold the felt tip pen in use position, and upon a further forward movement or pressing of the use position, the locking connection between the pin and the control and locking curve is released and the felt tip pen 2a is moved back into the non-use position by the action of the compression spring 26.

The invention was described above based on exemplary embodiments. It goes without saying that numerous alterations and modifications are possible, without abandoning the underlying inventive idea of the invention.

Reference Symbols
1, 1a writing utensil
2, 2a pen
3 protective sleeve for pen 2
4 pen body
5 closure element
6 closure cap
6.1, 6.2, 6.3 section of the closure cap
7 writing or drawing tip
8 sleeve body of the protective sleeve
8.1 section of the protective sleeve
8.2 fin
9 aperture
10 cap made of rubber-elastic material
10.1 wall of the cap 10
10.2 bottom of the cap 10
11 aperture
12 spring
13 locking mechanism
14 outer sleeve or casing
14.1, 14.2 sleeve section
15 felt tip pen body
15.1 end
15.2 section
15.3 ring-shaped bead
16 writing tip
16.1, 16.2 end of the writing and drawing tip
17 layer
18 closure element
18.1 edge area
19 protective space
20 hinge
21 elastomer material
22 edge seal
22′ material strip
23 break-off line
24 ring seal
25 collar
26 compression spring
27 collar
28 leaf spring type section
29 locking pin
30 holding clip
L longitudinal axis of the drawing and/or writing utensil

1. A writing and/or drawing utensil with an inner writing and/or drawing element or pen, which comprises a writing and/or drawing tip on a pen body and a reservoir in the pen body that supplies the writing and/or drawing tip with a writing and/or drawing liquid, with an outer casing in which the pen can move axially and which forms a protective room or space at one end into which the pen body extends with one end containing the writing and/or drawing tip and which can be closed at one end of the outer casing toward the outside of the casing by a closure, whereby the closure upon moving of the pen relative to the casing from a non-use position in which the writing and/or drawing tip and the end of the pen body containing this tip are accommodated in the protective space, into a use position, the closure opens and the writing and/or drawing tip protrudes through a closure aperture freed by the open closure from the end of the casing containing this closure aperture, wherein the closure opens the closure aperture by spreading and that the end of the pen body containing the writing and/or drawing tip forms at least one first control surface which upon moving of the pen from the non-use position into the use position comes to bear against the inner surfaces of the closure in order to open the closure by spreading.

2. The utensil as claimed in claim 1, wherein the outer casing is a sleeve.

3. A utensil as claimed in claim 1, wherein the closure is formed by a spreading mechanism.

4. A utensil as claimed claim 3, wherein the spreading mechanism forms inner control surfaces that act together with a section of the pen outside of the writing or drawing tip for spreading the spreading element and opening the closure aperture.

5. The utensil as claimed in claim 3, wherein the control surfaces of the spreading mechanism form an acute angle with the axis (L) of the protective sleeve or of the pen on an imaginary cone surface on this axis (L).

6. The utensil as claimed in claim 3, the closure aperture is located in a part of the closure made of a rubber-elastic material that can be expanded by the spreading mechanism for opening the closure aperture.

7. The utensil as claimed in claim 3, wherein the closure aperture is confined by at least one closure lip, which is made of a rubber-elastic material and is operated by means of the spreading mechanism for opening and closing the closure aperture.

8. The utensil as claimed in claim 3, wherein the spreading mechanism is formed by a plurality of fins, which are distributed on the longitudinal axis (L) of the protective sleeve or of the pen and in a non-spread state of the spreading mechanism form an angle smaller than 90° with the longitudinal axis (L) and that extend with their free ends into the proximity of the closure aperture.

9. The utensil as claimed in claim 8, wherein the closure aperture is located in the bottom of a cap made of a rubber-elastic material that is located on the fins and closes the protective sleeve in the area of these fins.

10. The utensil as claimed in claim 9, the spreading mechanism consists of a material that has a higher material hardness than the permanently elastic material closing and/or sealing the closure aperture.

11. The utensil as claimed in claim 8, wherein the fins or the control surfaces formed by these fins are located freely within the cap made of the rubber-elastic material.

12. The utensil as claimed in claim 9, wherein the cap made of the rubber-elastic material is supported by the fins or the radially outer surfaces of these fins.

13. The utensil as claimed in claim 8, wherein the spreading mechanism or the fins forming this spreading mechanism are manufactured as one piece with the protective sleeve.

14. The utensil as claimed in claim 8, wherein the part of the protective sleeve closure containing the closure aperture made of the rubber-elastic material is molded onto the spreading element or onto the fins forming this spreading element.

15. The utensil as claimed in claim 1, further comprising spring means acting between the protective sleeve and the pen by means of which the pen is pre-tensioned in its non-use position.

16. The utensil as claimed in claim 1, further comprising means for locking the pen in its use position.

17. The utensil as claimed in claim 3, wherein the closure or the spreading mechanism forming this closure comprises a plurality of closure elements, which in closed state form the cap-shaped or cone-shaped casing end and are hinged on the outer casing or on a section of this casing.

18. The utensil as claimed in claim 17, wherein the closure elements are manufactured as one piece with the outer casing A* or casing section.

19. The utensil as claimed in claim 17, wherein the hinges are formed by reduction of the material forming the outer casing or casing section and that in the corresponding space created by the reduction of the wall thickness there is a material that has a higher elasticity than the material of the outer casing.

20. The utensil as claimed in claim 17, wherein the closure elements are provided with an elastic edge seal on their adjacent edge areas.

21. The utensil as claimed in claim 20, wherein the edge seals are formed by a material fin or strip made of an elastic material that connects the closure elements on their adjacent edge areas and has a break-off line that extends parallel to the adjacent edge areas and at which the material fin has a reduced wall thickness.

22. The utensil as claimed in claim 1, further comprising at least one seal, which encloses the end of the pen body containing the writing and/or drawing tip both in the use position and in the non-use position and closes the protective space (19) also on the side opposite the closure aperture.

23. The utensil as claimed in claim 22, further comprising a pull-back spring that pre-tensions the pen in the non-use position and is supported with one end on the pen and with the other end on the ring seal pressing the latter against a collar on the inside of the outer casing.

24. The utensil as claimed in claim 23, wherein the pen body on its end containing the writing and/or drawing tip has a section with an enlarged outer diameter that bears against the ring seal in non-use position.

25. The utensil as claimed in claim 1, further comprising a locking mechanism for locking the pen in use position in a manner that can be released.

26. The utensil as claimed in claim 25, wherein the locking mechanism is formed by a control surface on a holding clip and by a locking or control element on the pen or on an element connected with the pen that acts together with said control surface.

27. The utensil as claimed in claim 1, wherein the outer casing in the proximity of the closure has a gripping surface on the outside that is made of a material that is softer than the material of the outer casing.

28. The utensil as claimed in claim 1, wherein the outer casing with the gripping surface and/or the elastic material inserts and/or the at least one ring seal and/or the edge seals and/or the material fins forming these edge seals is manufactured using the multi-injection molding process.

29. A casing or protective sleeve for a writing and/or drawing element or pen that comprises a writing and/or drawing tip on a pen body and a reservoir in the pen body that supplies the writing and/or drawing tip with a writing and/or drawing liquid, e.g. ink, with an outer casing in which the pen can move axially and which forms a protective room or space at one end into which the pen body extends with one end containing the writing and/or drawing tip and which can be closed at one end of the outer casing toward the outside of the casing by a closure, whereby the closure upon moving of the pen relative to the casing from a non-use position in which the writing and/or drawing tip and the end of the pen body containing this tip are accommodated in the protective space, into a use position, the closure opens and the writing and/or drawing tip protrudes through a closure aperture released by the open closure from the end of the casing containing this closure aperture, wherein the closure opens the closure aperture by spreading and that the end of the pen body containing the writing and/or drawing tip forms at least one first control surface which upon moving of the pen from the non-use position into the use position comes to bear against the inner surfaces of the closure in order to open the closure by spreading.

30. The casing or protective sleeve as claimed in claim 29, wherein the outer casing is a sleeve.

31. The casing or protective sleeve as claimed in claim 29, wherein the closure is formed by a spreading mechanism.

32. The casing or protective sleeve as claimed in claim 29, wherein the spreading mechanism forms inner control surfaces that act together with a section of the pen outside of the writing or drawing tip for spreading the spreading element and opening the closure aperture.

33. The casing or protective sleeve as claimed in claim 29, wherein the control surfaces of the spreading mechanism (8.2) form an acute angle with the axis (L) of the protective sleeve (3) or of the pen (2) on an imaginary cone surface on this axis (L).

34. The casing or protective sleeve as claimed in claim 29, wherein the closure aperture m is located in a part of the closure made of a rubber-elastic material that can be expanded by the spreading mechanism for opening the closure aperture.

35. The casing or protective sleeve as claimed claim 29, wherein the closure aperture is confined by at least one closure lip, which is made of a rubber-elastic material and is operated by means of the spreading mechanism for opening and closing the closure aperture.

36. The casing or protective sleeve as claimed in claim 29, wherein the spreading mechanism is formed by a plurality of fins, which are distributed on the longitudinal axis (L) of the protective sleeve or of the pen and in a non-spread state of the spreading mechanism form an angle smaller than 90° with the longitudinal axis (L) and that extend with their free ends into the proximity of the closure aperture.

37. The casing or protective sleeve as claimed in claim 29, wherein the closure aperture is located in the bottom of a cap made of a rubber-elastic material that is located on the fins and closes the protective sleeve in the area of these fins.

38. The casing or protective sleeve as claimed in claim 37, wherein the spreading mechanism consists of a material that has a higher material hardness than the permanently elastic material closing and/or sealing the closure aperture.

39. The casing or protective sleeve as claimed in claim 29, wherein the fins or the control surfaces formed by these fins lie freely within the cap made of the rubber-elastic material.

40. The casing or protective sleeve as claimed in claim 29, wherein the cap made of the rubber-elastic material is supported by the fins or the radially outer surfaces of these fins.

41. The casing or protective sleeve as claimed in claim 29, wherein the spreading mechanism or the fins forming this spreading mechanism are manufactured as one piece with the protective sleeve preferably of plastic.

42. The casing or protective sleeve as claimed in claim 29, wherein the part of the protective sleeve closure containing the closure aperture made of the rubber-elastic material is molded onto the spreading element or onto the fins forming this spreading element.

43. The casing or protective sleeve as claimed in claim 29, further comprising spring means 9 acting between the protective sleeve and the pen by means of which the pen is pre-tensioned in its non-use position.

44. The casing or protective sleeve as claimed in claim 29, further comprising means for locking the pen in its use position.

45. The casing or protective sleeve as claimed in claim 29, wherein the closure or the spreading mechanism forming this closure comprises a plurality of closure elements which in closed state form the cap-shaped or cone-shaped casing end and are hinged on the outer casing or on a section of this casing.

46. The casing or protective sleeve as claimed in claim 45, wherein the closure elements are manufactured as one piece with the outer casing or casing section.

47. The casing or protective sleeve as claimed in claim 45, wherein the hinges are formed by reduction of the material forming the outer casing or casing section and that in the corresponding space created by the reduction of the wall thickness there is a material that has a higher elasticity than the material of the outer casing.

48. The casing or protective sleeve as claimed in claim 29, wherein the closure elements are provided with an elastic edge seal on their adjacent edge areas.

49. The casing or protective sleeve as claimed in claim 48, wherein the edge seals are formed by a material fin or strip made of an elastic material that connects the closure elements on their adjacent edge areas and has a break-off line that extends parallel to the adjacent edge areas and at which the material fin has a reduced wall thickness.

50. The casing or protective sleeve as claimed in claim 29, further comprising at least one seal which encloses the end of the pen body containing the writing and/or drawing tip both in the use position and in the non-use position and closes the protective space also on the side opposite the closure aperture, toward the remaining interior of the outer casing.

51. The casing or protective sleeve as claimed in claim 50, further comprising a pull-back spring that pre-tensions the pen in the non-use position and is supported with one end on the pen A and with the other end on the ring seal, pressing the latter against a collar on the inside of the outer casing.

52. The casing or protective sleeve as claimed in claim 29, wherein the pen body on its end containing the writing and/or drawing tip has a section with an enlarged outer diameter that bears against the ring seal in non-use position.

53. The casing or protective sleeve as claimed in claim 29, further comprising a locking mechanism for locking the pen in use position in a manner that can be released.

54. The casing or protective sleeve as claimed in claim 53, wherein the locking mechanism is formed by a control surface on a holding clip and by a locking or control element on the pen or on an element connected with the pen that acts together with said control surface.

55. The casing or protective sleeve as claimed in claim 29, wherein the outer casing in the proximity of the closure has a gripping surface on the outside that is made of a material that is softer than the material of the outer casing.

56. The casing or protective sleeve as claimed in claim 55, wherein the outer casing with the gripping surface and/or the elastic material inserts and/or the at least one ring seal and/or the edge seals and/or the material fins forming these edge seals is manufactured using the multi-injection molding process.

57. A casing or protective sleeve for a pen that comprises a writing or drawing tip on a pen body and a reservoir in the pen body that supplies the writing or drawing tip with a writing or drawing liquid wherein a protective sleeve body accommodating the pen at least on its end containing the writing or drawing tip, in which the pen is axially movable and forms a closure on its end adjacent to the writing or drawing tip with a closure aperture that upon moving the pen relative to the protective casing from a non-use position, in which the writing and drawing tip is accommodated within the protective casing, into a use position, in which the writing or drawing tip protrudes from the protective casing, automatically opens for the writing or drawing tip to pass through, whereby the closure is formed by a spreading mechanism, which tightly closes the closure aperture in non-use state and upon moving of the pen into the use position opens by spreading to allow the writing or drawing tip to pass through.
